(19) United States
(12) Patent Application Publication
(10) Pub. No.: US 2012/0278096 A1
(43) Pub. Date: Nov. 1, 2012

(54) METHODS AND SYSTEMS FOR PRESCRIPTION DRUG AUTHENTICATION IN SUPPLY CHAIN AND MARKET DISTRIBUTION

(76) Inventor: David Anthony Holness, Woodstock, GA (US)

(21) Appl. No.: 13/454,652

(22) Filed: Apr. 24, 2012

Related U.S. Application Data
(60) Provisional application No. 61/480,185, filed on Apr. 28, 2011.

(51) Int. Cl. G06Q 50/22; G06Q 10/08

(52) U.S. Cl. 705/2

(57) ABSTRACT

The present invention generally relates to systems, methods and devices for prescription drug authentication and more specifically a portable hand-held device and system for prescription drug authentication to be conducted ad hoc. Although preferred embodiments of the invention are explained in detail, it is to be understood that other embodiments are contemplated.

Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity.

This application claims priority to the provisional application Ser. No. 61/480,185. Certain embodiments of the present disclosure generally relate to electronically tracking and tracing prescription drugs by the use of serialized numbering of the package of distribution (unit), a.k.a. e-pedigree. Another form of identification of prescription drugs involves the spectral analysis of the medication itself for identification and authentication respectively.

### BACKGROUND

### Technical Field

Approximately 1.3 million people in the United States are injured'annually following so-called “medication errors.” The National Coordinating Council for Medication Error Reporting and Prevention defines a medication error as “any preventable event that may cause or lead to inappropriate medication use or patient harm while the medication is in the control of the health care professional, patient, or consumer . . . related to professional practice, health care products, procedures, and systems, including prescribing; order communication; product labeling, packaging, and nomenclature; compounding; dispensing; distribution; administration; education; monitoring; and use.” (US, FDA 2009)

Federal and state prescription drug regulatory agencies and the pharmaceutical industry are updating the current system of tracking and tracing prescription drug packages from manufacturer to pharmacy to include electronic means of tracking by serial number. Unfortunately, this approach doesn't directly address the problem of tampering with the content of the package. There remains a need to actually authenticate what's in the package, the medication itself. Routinely, as part of the distribution process the actual medication in the package is removed, repackaged and sometimes contraband and adulterated drugs substituted, which reach pharmacies and unsuspecting patients having defeated prescription drug pedigree measures. The methods and systems identified in this application are respectfully submitted. to address current and ongoing safety and security issues in the pharmaceutical supply chain.

### SUMMARY OF THE DISCLOSURE

Certain embodiments provide a method for selection of a unit (drug package) by a randomized, non-zero probability process. The testing party examines the contained prescription drug using a spectrographic instrument; e.g. handheld, portable or similar device capable of analyzing the compound and producing a spectral signature. A comparison of the spectral signature is made in a dataset of known spectral signatures representing pharmaceutical ingredients.

Certain embodiments provide a method of identifying and comparing the active pharmaceutical ingredients (API) and inactive pharmaceutical ingredients (IPI) found in the sample with those of ingredients found in prescription drug datasets in U.S. regulatory agencies; e.g. Health and Human Services, (HHS) Food and Drug Administration, (FDA) National Library of Medicines, (NLM), etc. for the purpose of identifying the prescription drug (s) comprised of those ingredients. A prescription drug and manufacturer correctly identified by this process is considered authenticated for the purpose of this claim.

Certain embodiments provide a system and process for identifying a prescription drugs by query of a database system authorized to track and trace prescription drugs or similar means for the purpose of monitoring the movements and sale of pharmaceutical products through a supply chain; a.k.a. e-pedigree trail; serialized numerical identification (SNI), stock keeping units (SKU), point of sale system (POS), systems etc. in order to compare the information; e.g. drug name, manufacturer, etc. to the drug identified by the track and trace system and to ensure that it is the same drug and manufacturer of origin.

Certain embodiments provide a system and process to verify authenticity and check pedigree which can be conducted at any point along the prescription drug supply chain; e.g. wholesaler, distributor, doctor's office, pharmacy. The most optimal point for execution of this process would be where regulatory authorities view the greatest vulnerability to the supply chain's integrity. For example, this examination process could occur in pharmacy operations prior to containerization and distribution to the pharmacy for dispensing to patients.

Certain embodiments provide a system and process by which an authenticated prescription drug with verified drug pedigree trail will render an informational object, which for the purpose of illustration will be represented but not be limited to a unique mark; e.g. QR Code, Barcode, Watermark, Stealth Dots, Seal or 2 Dimensional graphical symbol, hereinafter called a certificate, seal, or mark.

An exemplary embodiment for use of said certificate, mark, or seal can be used by authorized entities as a warrant of the prescription drug's authenticity and pedigree. For example, when this seal is appended to a prescription vial presented to a patient by a licensed pharmacy, it would represent the prescription drug has gone through an authentication and logistics validation process authorized by a regulatory agency (s); e.g. HHS, FDA, NABP, VIPP, etc.

An exemplary embodiment for use of said certificate, mark or seal would be analogous to that of the functioning features, marks, seals, and distinguishing characteristics that currently authenticate paper money and further make it difficult to counterfeit. Furthermore, authorized agents utilizing the certificate process would be analogous to banks participating in the FDIC program.

Certain embodiments provide that a user; e.g. patient equipped with the appropriate application on a portable or handheld device can scan the certificate, mark or seal and receive an audible and visible confirmation of the prescription drug's name, and manufacturer. This will constitute a confirmation of the authenticity of the dispensed prescription drug.

Certain embodiments provide that extensible use of the certificate, mark, or seal will include but not be limited to; gaining access to website (s) where additional information or interactive functions can be performed; e.g. audible narration of the drug's characteristics and physical property descriptions, dosing, information, and publications, etc.

Certain embodiments provide that a user; e.g. patient equipped with the appropriate application on a portable or handheld device can scan the certificate, mark, or seal and be provided with notifications regarding; e.g. immediate recall of the medication, adverse events, new formulations, critical warnings of an immediate and emergency nature made by prescription drug regulatory authorities and, or their agents.

Certain embodiments provide that a user; e.g. patient equipped with a portable or handheld device with the appropriate application software can use the portable and, or handheld device to store prescription drug information in a secure, non-editable format on their device for personal use; e.g. MD's Office Visits, Records Management, Future Authentications, Emergency use by first responders etc.

Certain embodiments provide that a user; e.g. patient equipped with the appropriate application on a portable or handheld device can scan the drug via an optical scan, picture capture, spectroscopy or other means of identifying its physical properties and characteristics; e.g. spectral signature, size, shape, color, texture, opacity, etc and use this data to identify the prescription drug's name, and manufacturer.

Certain embodiments provide that a user; e.g. patient equipped with the appropriate application on a portable or handheld device and having the certification system can receive updated information (as a subscriber in a client/server relationship) on a continuing or as needed ad hoc basis (as permitted) about notifications made by prescription drug regulatory authorities regarding; e.g. immediate recall of medications, adverse events, new formulations and critical warnings of an immediate and emergency nature.

Certain embodiments provide that a user; e.g. patient, subscriber to the certificate system equipped with the appropriate application on a portable or handheld device will be notified by audible and visible warnings of potential adverse affects between drug combinations stored in their device's memory of previously “Certified Drugs.”

Certain embodiments provide that a user; e.g. patient subscriber to the certification system equipped with the appropriate application on a portable or handheld device will receive notification of potential adverse affects from drug combinations, as reported and published by medical professionals in documents and databases reported to; e.g. Drug Enforcement Administration (DEA), Health and Human Services, (HHS) Food and Drug Administration, (FDA) National Library of Medicines, (NLM) and their agents; e.g., Daily Med, Pillbox, RX Scan, PDR, etc.

### BRIEF DESCRIPTION OF THE DRAWINGS

In order for the above recited features of the present disclosure to be understood in detail, a more particular description of the disclosure briefly summarized above, may be had by reference to embodiments, some of which are illustrated in the appended drawings. It is to be noted, however, that the appended drawings illustrate only typical embodiments of this disclosure and are therefore not to be considered limiting of its scope for the disclosure may admit other equally effective embodiments.

FIG. 1 describes the process of generating the primary data elements to be used in authenticating a prescription drug in accordance with embodiments of the present disclosure.

FIG. 2 describes the process of using the primary data elements in a database for comparison in accordance with embodiments of the present disclosure.

FIG. 3 illustrates the process of conducting spectrographic and optical scanning and development of a spectral signature and data image representing a unit and sample of a prescription drug in accordance with embodiments of the present disclosure.

FIG. 4 illustrates the process of generating a unique serial number for each package unit being placed in the supply chain for the purpose of tracking and tracing prescription drugs from manufacturer to retailer; a.k.a. E-Pedigree.

FIG. 5 illustrates the merger and comparison of the prescription drug identified from FIG. 3 with the SNI for the prescription drug from FIG. 4 for the purpose of generating a positive match and generating an authentication certificate; e.g. seal, mark, symbol, etc. or rejecting and notifying authorities in accordance with embodiments of the present disclosure.

FIG. 6 illustrates the dispensing of a prescription medication with a certificate and the subsequent scanning of said certificate and or seal for the purpose of authentication in accordance with embodiments of the present disclosure.

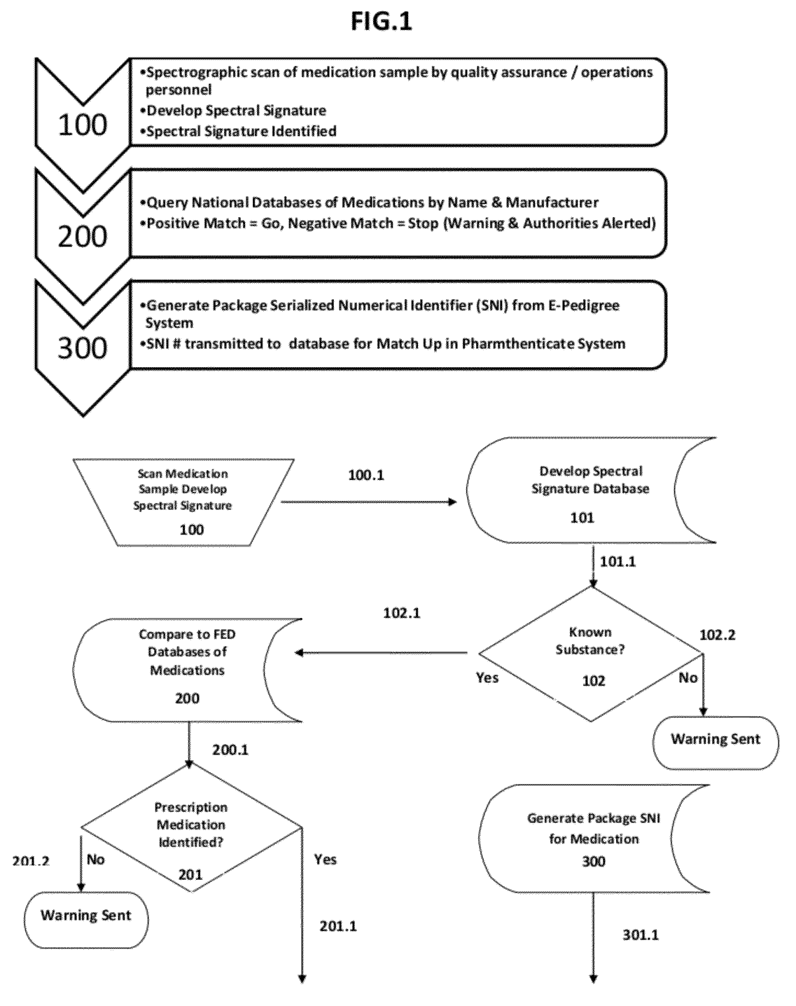

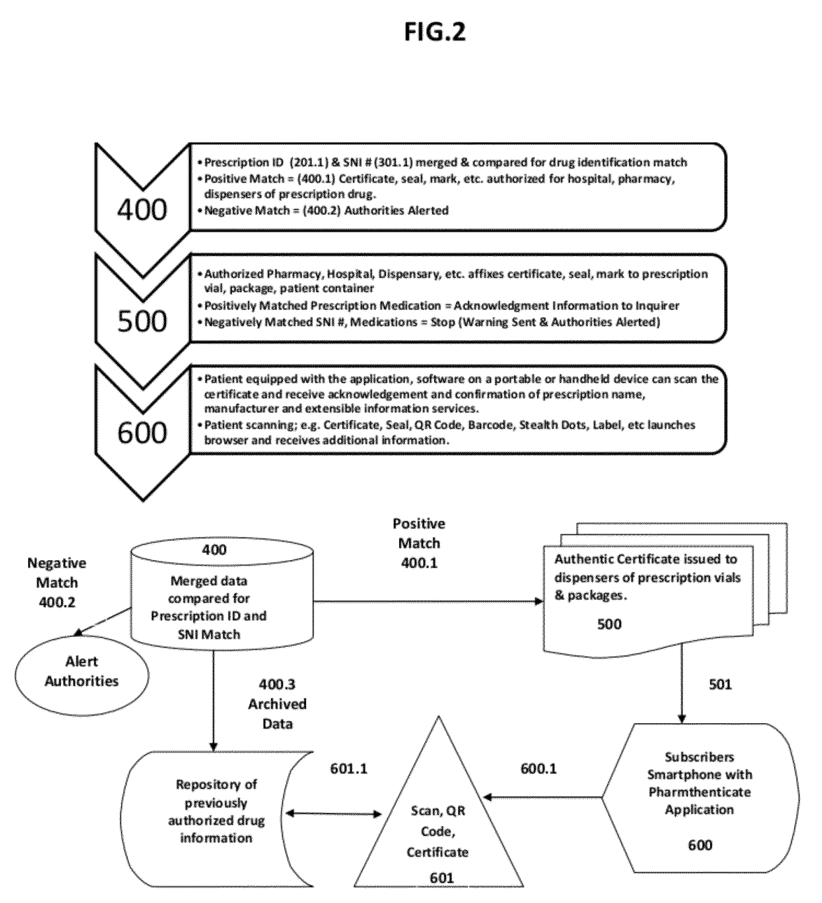

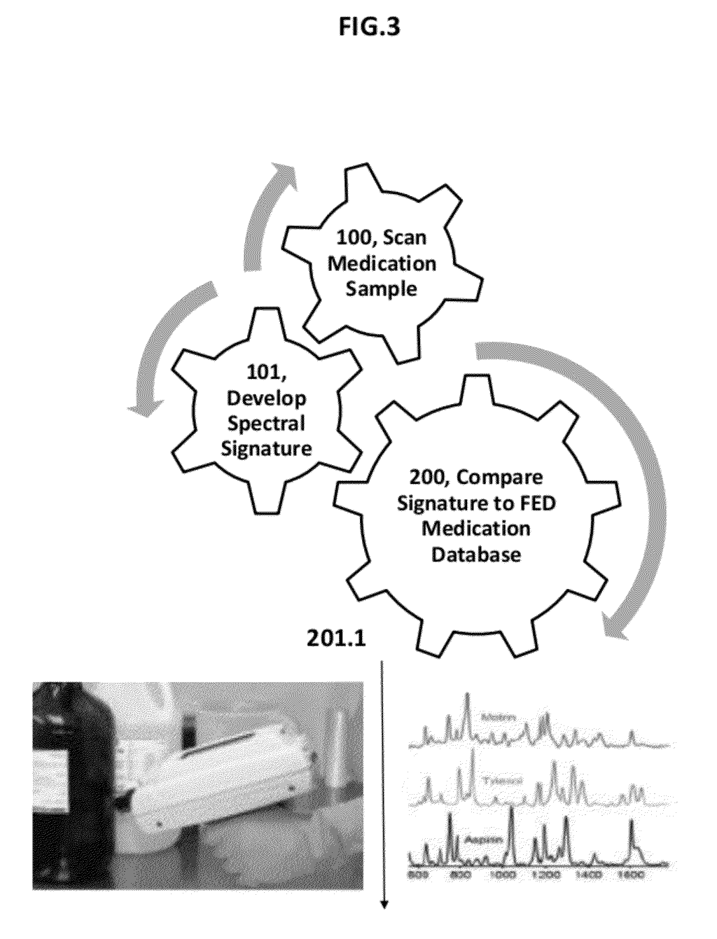

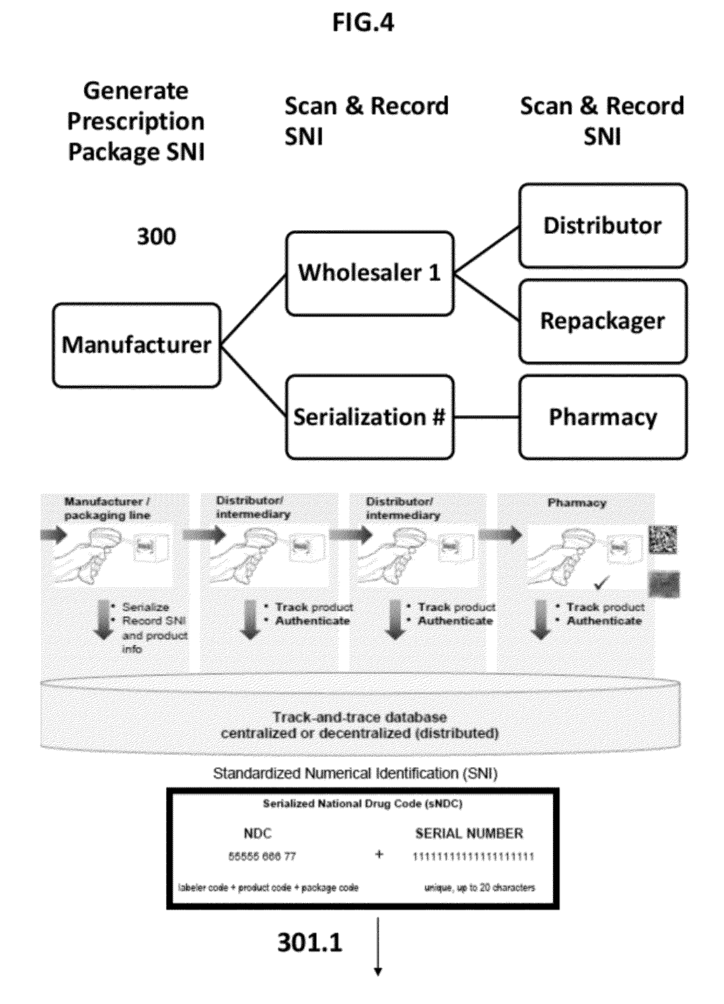

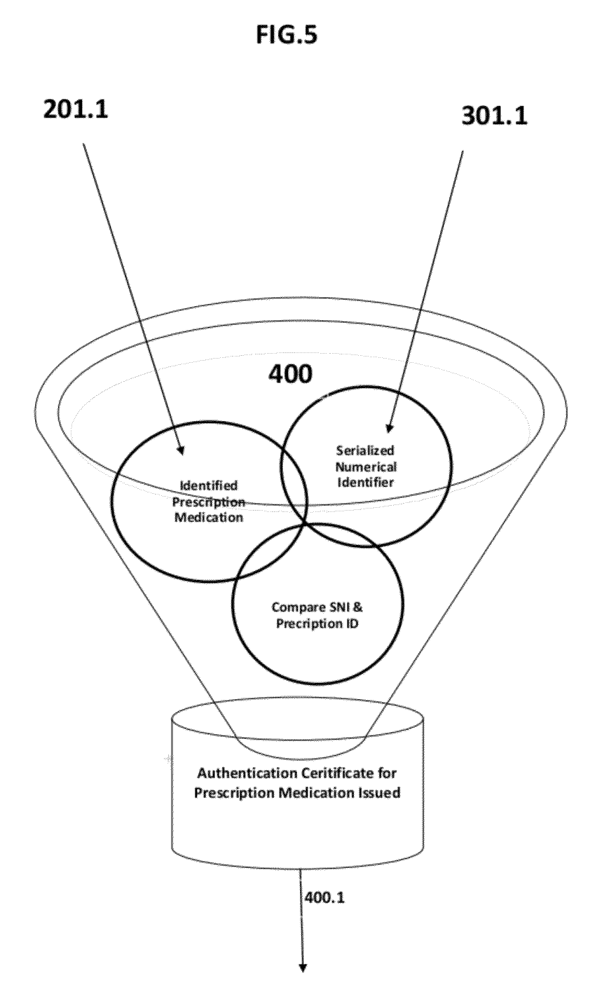

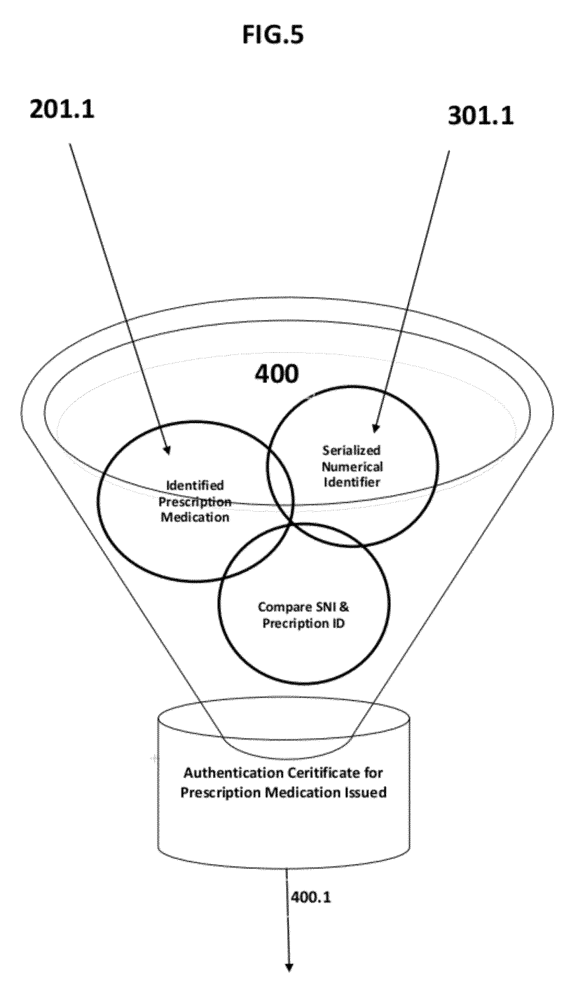

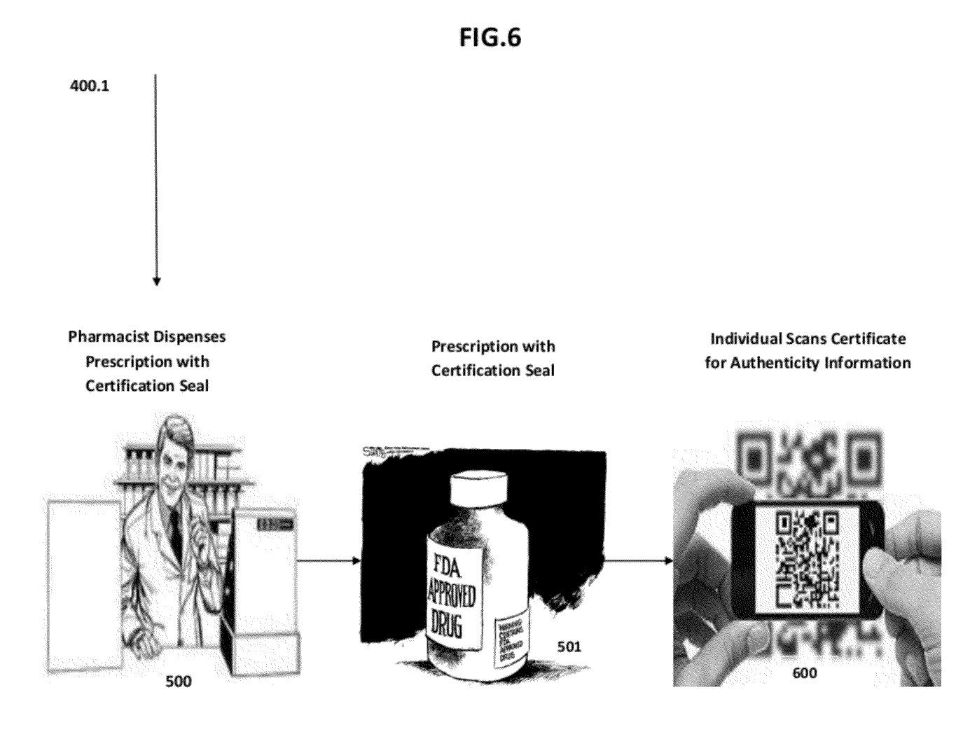

### DETAILED DESCRIPTION

Numerous characteristics and advantages have been set forth in the foregoing description, together with details of structure and function. While the invention has been disclosed in a particular form, it will be apparent to those skilled in the art that many modifications, additions, and deletions, especially in matters of shape, size, and arrangement of parts, can be made therein without departing from the spirit and scope of the invention and its equivalents asset forth in the following claims. Therefore, other modifications or embodiments as can be suggested by the teachings herein are particularly reserved as they fall within the breadth and scope of the claims here appended.

Embodiments of the present invention can be utilized in a computing environment and computer systems thereof. The computing environment and computer systems represent only one example of a suitable computing environment and computer systems for the practice of the present invention and are not intended to suggest any limitation as to the scope of use or functionality of the invention. Nor should the computer systems be interpreted as having any dependency or requirement relating to any one or combination of components disclosed hereinafter.

Hence, it should be understood that the present invention is operational with numerous other general purpose or special purpose computing system environments or configurations. Examples of well-known communication devices, computing systems, environments, and/or configurations that may be appropriate or suitable for use with the present invention include, but are not limited to, personal computers, server computers, hand-held or laptop devices, multiprocessor systems, microprocessor-based systems, set top boxes, programmable consumer electronics, network personal computers, minicomputers, mainframe computers, distributed computing environments that include any of the above systems or devices, and the like.

The present invention may also be described in the general context of comprising computer-executable instructions, such as program modules, being executed by a computer system. Generally, program modules include routines, programs, programming, objects, components, data, and/or data structures that perform particular tasks or implement particular abstract data types.

The present invention may be practiced in distributed computing environments where tasks are performed by remote processing devices that are linked through a communications network. In a distributed computing environment, program modules may be located in both local and remote computer storage media, including, without limitation, in memory storage devices.

An exemplary computing environment of the present invention includes a general purpose computing device in the form of a computer system. Components of computer system may include, but are not limited to, a processing unit, a system memory, and a system bus that couples various system components including the system memory to the processing unit for bi-directional data and/or instruction communication. The system bus may be any of several types of bus structures including a memory bus or memory controller, a peripheral bus, and a local bus using any of a variety of bus architectures. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (i.e., also known as the “Mezzanine bus”).

The computer system typically includes a variety of computer-readable media. Computer-readable media may comprise any available media that may be accessed by, read from, or written to by computer system, and may include both volatile and nonvolatile, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data, data structures, program modules, programs, programming, or routines. Computer storage media includes, but is not limited to, RAM, ROM, EEPROM, flash memory or other memory technology, CD-ROM, digital versatile disks (DVD) or other optical disk storage, magnetic cassettes, magnetic tape, magneto-optical storage devices, magnetic disk storage or other magnetic storage devices, or any other medium which may be used to store the desired information and which may be accessed by the computer system. Communication media typically embodies computer-readable instructions, data, data structures, program modules, programs, programming, or routines in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer-readable media.

The system memory includes computer storage media in the form of volatile and/or nonvolatile memory such as read only memory (ROM) and random access memory (RAM). A basic input/output system (BIOS), containing the basic routines that direct the transfer of information between elements within computer, such as during start-up, is typically stored in ROM. RAM typically stores data and/or program instructions that are immediately accessible to and/or presently being operated on by the processing unit. By way of example, and not limitation, the operating system, application programs, other program modules, and program data may be resident in RAM, in whole or in part, from time-to-time.

The computer may also include other removable/non-removable, volatile/nonvolatile computer storage media. By way of example only, they can include a hard disk drive that reads from or writes to non-removable, nonvolatile magnetic media, a magnetic disk drive that reads from or writes to a removable, a nonvolatile magnetic disk, and an optical disk drive that reads from, or writes to a removable, nonvolatile optical disk such as a CD ROM or other optical media. Other removable/non-removable, volatile/nonvolatile computer storage media that may be included in the exemplary computing environment include, but are not limited to, magnetic tape cassettes, flash memory cards, digital versatile disks, digital video tape, solid state RAM, solid state ROM, and the like. The hard disk drive is typically connected to the system bus through a non-removable memory interface such as interface, and the magnetic disk drive and optical disk drive are typically connected to the system bus by a removable memory interface.

The drives and their associated computer storage media described above provide storage of computer-readable instructions, data, data structures, program modules, programs, programming, or routines for the computer system. For example, the hard disk drive can store an operating system, application programs, other program modules, and program data. A user may enter commands and information into the computer system through connected input devices such as a keyboard and pointing device, commonly referred to as a mouse, trackball or touch pad. Other connected input devices may include a microphone, joystick, game pad, satellite dish, scanner, or the like. These and other input devices are often connected to the processing unit through a user input interface that is coupled to the system bus, but may be connected by other interface and bus structures, such as a parallel port, game port or a universal serial bus (USB). A monitor or other type of display device is also connected to the system bus via an interface, such as a video interface. In addition to the monitor, the computer system may also include other peripheral output devices such as speakers and printer, which may be connected through an output peripheral interface.

The computer system may operate in a networked environment using bi-directional communication connection links to one or more remote computer systems, such as a remote computer system. The remote computer system may be a personal computer, a laptop computer, a server computer, a router, a network PC, a peer device or other common network node, and typically includes many or all of the elements described above relative to the computer system. The bi-directional communication connection links can include a local area network (LAN) and a wide area network (WAN), but may also include other networks. Such networks are commonplace in offices, enterprise-wide computer networks, intranets and the Internet.

When communicatively connected to a LAN, the computer system connects to the LAN through a network interface or adapter. When communicatively connected to a WAN, the computer system typically includes a modem or other means for establishing a communication link, over the WAN, such as the Internet. The modem, which may be internal or external, may be connected to the system bus via the user input interface, or other appropriate mechanism. In a networked environment, program modules may be stored in the remote memory storage device. By way of example, and not limitation, application programs may reside in the memory storage device. It will be appreciated that the described network connections are exemplary and other means of establishing a bi-directional communication link between the computers may be used.

While the invention has been disclosed in its preferred forms, it will be apparent to those skilled in the art that many modifications, additions, and deletions can be made therein without departing from the spirit and scope of the invention and its equivalents, as set forth in the following claims.

What's claimed is:

1. A method for prescription drug authentication by means of examination of a certificate representing the prescription drug using a Portable Device, Smartphone, PDA or similarly equipped instrument capable of photographic and, or spectrographic analysis.

2. A method by which an identified spectral signature; e.g. representing the active pharmaceutical ingredients (API) and inactive pharmaceutical ingredients (IPI) and, or photograph is generated and matched to a dataset of known spectral signatures and drug images representing pharmaceutical medications.

3. A method by which a comparison/query of the medications and, or images identified in claim 2, are found to exist in current regulatory agencies datasets; e.g. Drug Enforcement Administration (DEA) Health and Human Services, (HHS) Food and Drug Administration, (FDA) National Library of Medicines, (NLM) etc. for the purpose of identifying the prescription drug'(s) and manufacture name indicated by those ingredients. A medication correctly identified by this process is considered authenticated for the purpose of this claim.

4. A method by which authenticated drugs from claim 3 are compared to a track and trace database system of prescription medications moving through a supply chain from manufacturer to retailer, dispenser; e.g. Pedigree Trail, Serialized Numerical Identification (SNI), Stock Keeping Units (SKU), Point of Sale System (POS) E-Pedigree Systems, etc.

5. A method by which the process from claim 4, will hereinafter be called the certification process, system, or application and the resulting data, informational object generated from claim 4 will hereafter be called a certificate, seal, mark and be represented by, but not limited to a 2 dimensional symbol; e.g. QR Code, Bar Code, Watermark, Stealth Dots, etc.

6. A method by which the certificate from claim 5 when used by authorized entities is a warrant of the prescription drug's authenticity and pedigree. For example, when this seal is appended to a prescription drug vial presented to a patient by a licensed pharmacy, it would represent the prescription has gone through an authentication and logistics validation process authorized by regulatory agencies prior to being dispensed.

7. A method by which an individual equipped with the appropriate application on a portable and, or handheld device can scan the certificate (mark) identified by claim 5 and receive an audible and visible confirmation of the prescription drug's name and manufacturer. This or similar message will constitute a confirmation of the authenticity of the dispensed prescription drug.

8. A method by which an individual and, or user scanning the mark identified in claim 5 with an appropriately equipped device; e.g. Smartphone, Tablet, PDA, etc. with the certificate application will gain access to a website(s) where additional information about the drug and, or interactive functions can be performed; e.g. audible narration of the drug's characteristics and physical property descriptions, dosing, information, and publications, etc.

9. A method by which an individual and, or user scanning the mark identified by claim 5 with an appropriately equipped device; e.g. Smartphone, Tablet, PDA, etc. with the certificate application can be provided with notifications regarding; e.g. immediate recall of the medication, adverse events, new formulations, critical warnings of an immediate and emergency nature made by prescription drug regulatory authorities and, or their agents.

10. A method by which an individual and, or user scanning the mark identified by claim 5 with an appropriately equipped device; e.g. Smartphone, Tablet,. PDA, etc. with the certificate application can use the portable and, or handheld device to store prescription drug information in a secure, non-editable format on their device for personal use; e.g. MD's Office Visits, Records Management, Future Authentications, Emergency use by first responders, etc.

11. A method by which an individual and, or user scanning the mark identified by claim 5 with an appropriately equipped device; e.g. Smartphone, Tablet, PDA, etc. with the certificate application can scan the drug via an optical scan, picture capture, spectroscopy or other means of identifying its physical properties and characteristics; e.g. spectral signature, size, shape, color, texture, opacity, etc. and use this data to identify the . prescription drug's name, and manufacturer.

12. A method by which an individual and, or user scanning the mark identified by claim 5 with an appropriately equipped device; e.g. Smartphone, Tablet, PDA, etc. with the certificate application can receive updated information (as a subscriber in a client/server relationship) on a continuing or as needed ad hoc basis (as permitted) about notifications made by prescription drug regulatory authorities regarding; e.g. immediate recall of medications, adverse events, new formulations and critical warnings of an immediate and emergency nature.

13. A method by which an individual and, or user scanning the mark identified by claim 5 with an appropriately equipped device; e.g. Smartphone, Tablet, PDA, etc. with the certificate application will be notified by audible and visible warnings of potential adverse affects between drug combinations stored in their device's memory of previously authenticated” drugs.

14. A method by which an individual and, or user scanning the mark identified by claim 5 will receive a potential adverse affect notification(s) arising from drug combinations as reported and published by medical professionals in documents and databases held by regulatory authorities and their agencies to include but not be limited to; e.g. United States, Health and Human Services, (HHS) Food and Drug Administration, (FDA) National Library of Medicines, (NLM) Drug Enforcement Administration (DEA) and their agents; e.g., Daily Med, Pillbox, RX Scan, PDR, etc.
